(19) United States
(12) Patent Application Publication
(10) Pub. No.: US 2007/0266421 A1
(43) Pub. Date: Nov. 15, 2007

(54) SYSTEM, METHOD AND COMPUTER PROGRAM PRODUCT FOR CENTRALLY MANAGING POLICIES ASSIGNABLE TO A PLURALITY OF PORTABLE END-POINT SECURITY DEVICES OVER A NETWORK

(75) Inventors: Vimal Vaidya, Fremont, CA (US); Silvia Siu, Palo Alto, CA (US)

Correspondence Address: LAW OFFICE OF PHILIP A STEINER, 1212 MARSH STREET, SUITE 3, SAN LUIS OBISPO, CA, 93401, US

(73) Assignee: Redcannon, Inc., Fremont, CA (US)

(21) Appl. No.: 11/383,154

(22) Filed: May 12, 2006

(51) Int. Cl. H04L 9/00

(52) U.S. Cl. 726/1

(57) ABSTRACT

A system, method and computer program product for centrally managing policies prescriptively assignable to a plurality of portable end-point security devices over a network is provided. Various embodiments incorporate an central management console configured to define a plurality of group folders on at least one administration server accessible by the plurality of portable end-point security devices, define separate policies for each of the plurality of group folders, assign the plurality of portable end-point security devices to one or more of the plurality of group folders in a many to many relationship such that the separate policies of the plurality of group folders are inherited by the portable end-point security devices when operatively coupled thereto. In an embodiment, the portable end-point security devices are disposed as a handheld computer peripheral device connectable to a computer system using a communications port.

### CROSS-REFERENCE TO RELATED APPLICATIONS

This application is a related application to U.S. patent application Ser. No. 10/739,552 filed on Dec. 17, 2003 and Ser. No. 10/796,324 filed on Mar. 8, 2004 to a common inventor and assignee. The aforementioned patent applications are hereby incorporated by reference in their entirety as if fully set forth herein.

### FIELD OF INVENTION

The present invention relates generally to a data processing system, method and computer program product and more specifically to centralized policy management of a portable end-point security device configured as a handheld computer peripheral.

### BACKGROUND

The corporate workforce is becoming increasingly mobile and dependent on accessing electronic information such as emails, documents, financial information, and maintaining contact with business associates while traveling or otherwise being displaced from a central work location. Frequently, workers carry laptops, cell phones, PDA's, Blackberries™ and integrated versions of the latter and former to stay in touch with their home offices. However, in the majority of situations, a worker will have access to a remote computer system owned and/or managed by a third party but is hesitant to use these available resources due to concerns of malware being installed on the remote computer systems and the possibility of another recovering sensitive, proprietary and/or personal information left behind in cookies, temporary files, browsing histories and the like. For example, Internet Cafes are becoming ubiquitous in most major cities around the world, as well as in most major hotel chains and larger airports; all of which have computing resources available that would allow a worker to check for important emails, send and receive documents and allow other forms of common electronic commerce if sufficient safeguards were available. Preferably, these safeguards would be disposed in a highly portable device which readily interfaces with these resources, prevents malware from compromising security or data integrity, provides trusted remote access to the worker's private network and further avoids leaving sensitive information behind. Lastly, the ability to simply and effectively manage, configure and update a plurality of such devices as needs change would be highly advantageous and appreciated by the ever expanding mobile workforce and corporate IT departments.

### SUMMARY

This disclosure addresses the deficiencies of the relevant art and provides exemplary systematic, methodic and computer program product embodiments which incorporates in various embodiments, an administration server coupled to a network and a plurality of portable end-point security devices in processing communications with the administration server over the network. The various embodiments presented herein provide exemplary mechanisms for centrally managing a variety of policy files downloadable into the plurality of portable end-point security devices using group folders and connection nodes. All portable end-point security devices (PEPS) associated with a group folder inherit the policy(ies) of their assigned group folder.

In an exemplary systematic embodiment, a system for centrally managing policies prescriptively assignable to a plurality of portable end-point security devices over a network is provided. The exemplary systematic embodiment comprises a central management console in processing communications with at least one administration server and configured to; define a plurality of group folders on the administration server accessible by the plurality of portable end-point security devices; define separate file-based policies for each of the plurality of group folders, assign the plurality of portable end-point security devices to one or more of the plurality of group folders in at least partial dependence on the defined separate policies, such that the separate policies are inherited by the portable end-point security devices from the assigned plurality of group folders when operatively coupled thereto.

In a related exemplary systematic embodiment, the assignment maps each of the plurality of portable end-point security devices to a plurality of individually assigned nodes having corresponding unique identifiers to those of the plurality of portable end-point security devices.

In another related exemplary systematic embodiment, each of the plurality of portable end-point security devices may be configured to enforce the inherited separate policies when operatively coupled to a computer system in processing communications with the administration server.

In various related exemplary systematic embodiments, the separate policies includes any of, an executable code, a data file, an object, an application policy, a security policy, a license policy, a malware policy, a configuration policy, a connectivity policy, a storage policy, an auditing policy, a document management policy and any combination thereof.

In other various related exemplary systematic embodiments, the separate policies may be distributed in an XML format to each of the plurality of portable end-point security devices as part of the inheritance. The XML format may include a digital signature, a checksum, encrypted information and any combination thereof.

To gain access to the administration server requires user authentication to at least one of the plurality of portable end-point security devices.

In another related exemplary systematic embodiment, the separate policies are distributed from the administration server to each of the plurality of portable end-point security devices in at least partial dependence on a unique identifier associated with each of the plurality of portable end-point security devices.

In another related exemplary systematic embodiment, a relational correspondence may exist between each of the plurality of group folders to each of the plurality of portable end-point security devices including a one-to-many relationship; and in another relational correspondence, each of the plurality of portable end-point to each of the plurality of group folders includes a many-to-many relationship.

In other related exemplary systematic embodiments, the separate policies may be sharable between two or more of the plurality of group folders; a member of the plurality of portable end-point security devices inherits the separate policies from each of the plurality of group folders to which the member is assigned; and where the member implements the more restrictive policies inherited.

In other related exemplary systematic embodiments, the proper credentials are first provided to the plurality of portable end-point security devices and another set of proper credentials is provided to the administrative server to access the assigned group folders; where the another set of proper credentials is obtained from a unique set of credentials internal to the plurality of portable end-point security devices; and information included in at least a portion of the separate policies is migrated from an X.500 compliant directory.

In various other related exemplary systematic embodiments, the plurality of group folders at least intermittently contain policy update files for inheritance by the selectively assigned plurality of portable end-point security devices; the separate policies may include different requirements based on trusted and untrusted configurations; where the trusted and untrusted configurations are dependent at least in part on one of, a local host connection, a network connection, a location, a network domain and any combination thereof; and where each of the plurality of portable end-point security devices comprises a handheld computer peripheral device connectable to a computer system through a communications channel.

In an exemplary methodic embodiment, a method for centrally managing policies prescriptively assignable to a plurality of portable end-point security devices over a network is provided. The exemplary methodic embodiment comprises; defining a plurality of group folders on at least one administration server; the plurality of group folders being permissively accessible by the plurality of portable end-point security devices upon presentation of proper credentials to at least the plurality of portable end-point security devices; defining separate file-based policies for each of the plurality of group folders; selectively assigning the plurality of portable end-point security devices to one or more of the plurality of group folders in at least partial dependence on the defined separate policies; where the separate policies are inherited by the portable end-point security devices from the assigned plurality of group folders when operatively coupled thereto.

In a related exemplary methodic embodiment, the process further includes assigning each of the plurality of portable end-point security devices to a plurality of individually assigned nodes having many-to-many relationships with the assigned plurality of group folders.

In various other related exemplary methodic embodiments, the process further includes; receiving a license policy from the at least one administration server or a third party service provider; first receiving a default policy from the at least one administration server or the third party service provider prior to inheriting the separate policies; accessing the at least one administration server at least intermittently to receive policy update files from the assigned plurality of group folders; authenticating a user to at least one of the plurality of portable end-point security devices prior to accessing the at least one administration server; and distributing the separate policies from the at least one administration server to each of the plurality of portable end-point security devices in at least partial dependence on the default policy.

In various other related exemplary methodic embodiment, the separate policies includes one of, an executable code, a data file, an object, an application policy, a security policy, a license policy, a malware policy, a configuration policy, a connectivity policy, a storage policy, an auditing policy, a document management policy and any combination thereof, and where each of the plurality of portable end-point security devices comprises a handheld computer peripheral device connectable to a computer system through a communications channel. Each of the plurality of portable end-point security devices is configured to enforce the inherited separate policies when operatively coupled to a computer system.

In an exemplary computer program product embodiment, executable instructions for a processor associated with at least one administration server embodied in a tangible form are provided. The executable instructions cause the processor to; generate a plurality of group folders on the at least one administration server; where the plurality of group folders being permissively accessible by a plurality of portable end-point security devices upon presentation of proper credentials to the at least one administration server; generate separate file-based policies for each of the plurality of group folders; selectively assign the plurality of portable end-point security devices to one or more of the plurality of group folders in at least partial dependence on the defined separate policies; and where the separate policies are inherited by the portable end-point security devices from the assigned plurality of group folders when operatively coupled thereto. Each of the plurality of portable end-point security devices is configured to enforce the inherited separate policies when operatively coupled to a computer system.

In a related exemplary computer program product embodiment, executable instructions are provided to cause the processor to; assign each of the plurality of portable end-point security devices to a plurality of nodes having unique identifiers corresponding to those of the plurality of portable end-point security devices.

In various other related exemplary computer program product embodiments; each of the plurality of portable end-point security devices comprises a handheld computer peripheral device connectable to a computer system through a communications channel; the separate policies are distributed in an XML format to each of the plurality of portable end-point security devices as part of the inherited process. The XML format may include a digital signature, a checksum, encrypted information and any combination thereof.

The assignment action maps each of the plurality of portable end-point security devices to a plurality of individually assigned nodes having many-to-many relationships to the assigned plurality of group folders; and the tangible form comprises magnetic media, optical media, logical media and any combination thereof.

### BRIEF DESCRIPTION OF THE DRAWINGS

The features and advantages will become apparent from the following detailed description when considered in conjunction with the accompanying drawings. Where possible, the same reference numerals and characters are used to denote like features, elements, components or portions. Optional components or feature are generally shown in dashed or dotted lines. It is intended that changes and modifications can be made to the described embodiments without departing from the true scope and spirit of the subject invention.

FIG. 1—depicts a generalized and exemplary block diagram of a general purpose computer system as described in the various embodiments.

FIG. 1A—depicts a detailed exemplary block diagram of the functional components of an administrative server as described in the various embodiments.

FIG. 1B—depicts a generalized and exemplary block diagram of a portable multifunction device.

FIG. 1C—depicts a detailed exemplary block diagram of the functional components of a portable end-point security device (PEPS) as described in the various embodiments.

FIG. 2—depicts an exemplary detailed block diagram of the interrelationships of the portable end-point security device (PEPS) with various networks and computer systems described in the various embodiments.

FIG. 3—depicts a first exemplary flow chart of a process for defining, distributing and updating information associated with the portable end-point security device (PEPS) as described in the various embodiments.

FIG. 3A—depicts a second exemplary flow chart of a process for defining, distributing and updating information associated with the portable end-point security device (PEPS) as described in the various embodiments.

FIG. 4—depicts an exemplary detailed block diagram of the file relationships associated with the portable end-point security device (PEPS) as described in the various embodiments.

### DETAILED DESCRIPTION

In various embodiments, the definition, management, control, distribution and auditing of various policies, license, data and documentation files are performed from an administration server in processing communications with a plurality of portable end-point security devices (PEPS) as is described in various exemplary embodiments contained herein. The PEPS provides a plurality of useful features for the mobile workforce including but not limited to; end-point security using industry standard authentication and connectivity mechanisms, malware protection, secure document file distribution and secure data storage. These and other integrated features provides a trusted platform from which mobile uses can remotely access their enterprise resources from untrusted computer systems without having to install software on the untrusted computer systems. Administration of the PEPS is performed using simple file centric policies created by a systems administrator which are downloaded either manually or automatically and enforced by the PEPS based on practical organizational group assignments.

Where necessary, computer programs, algorithms and routines are envisioned to be programmed in a high level, preferably an object oriented language, for example Java™, C, C++, C#, or Visual Basic™.

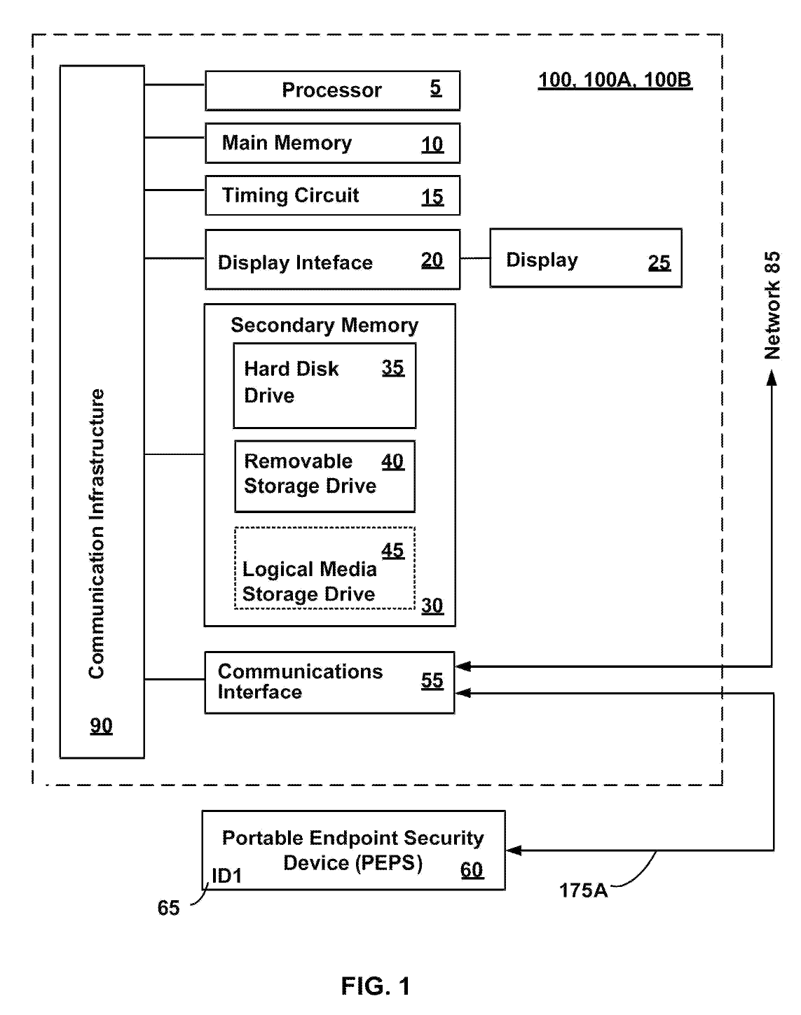

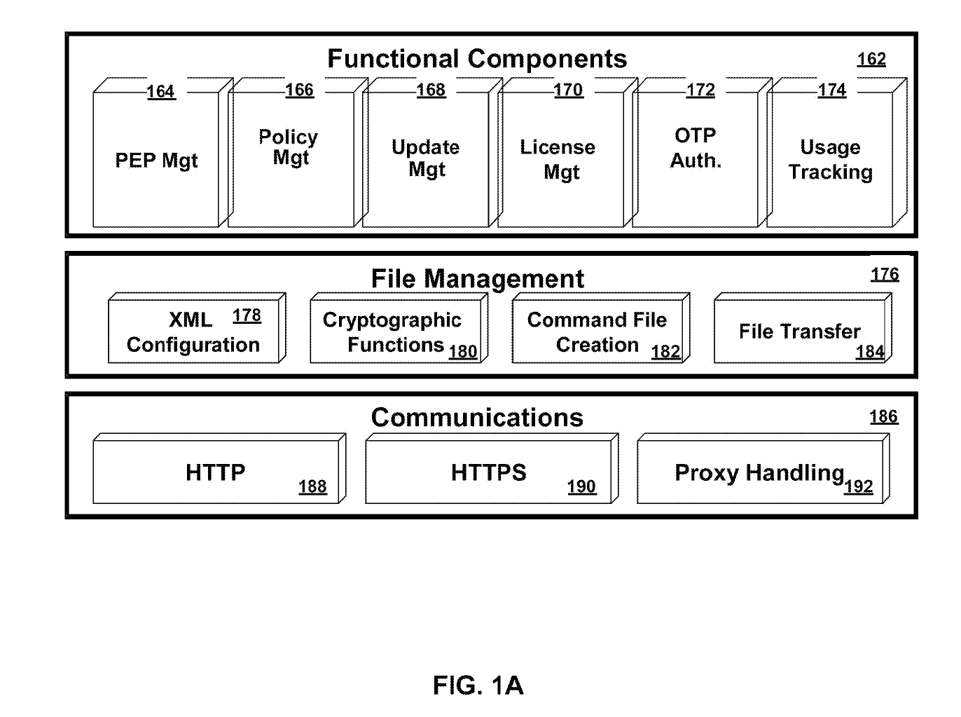

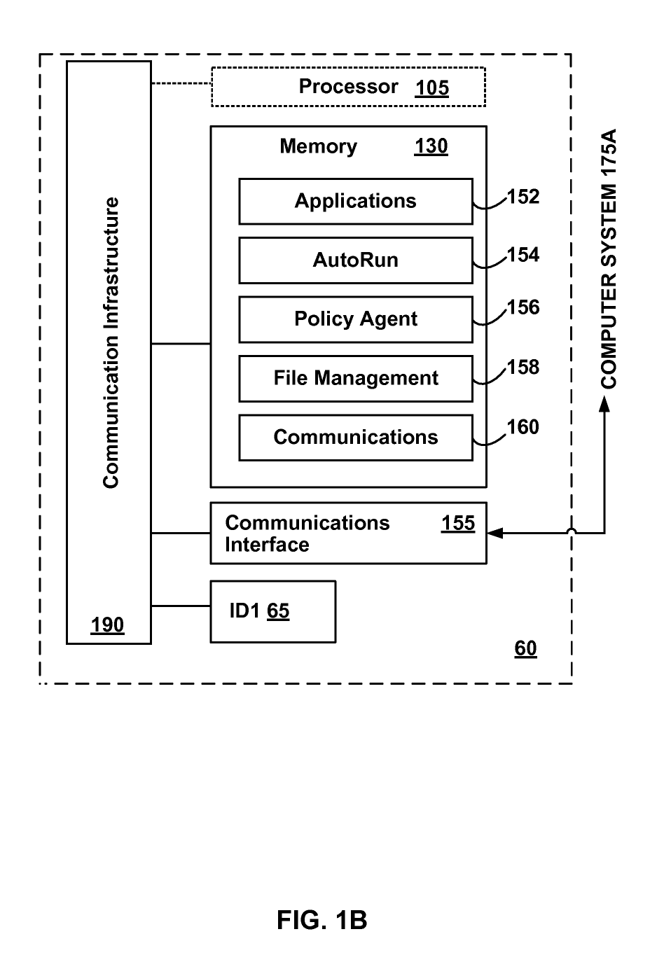

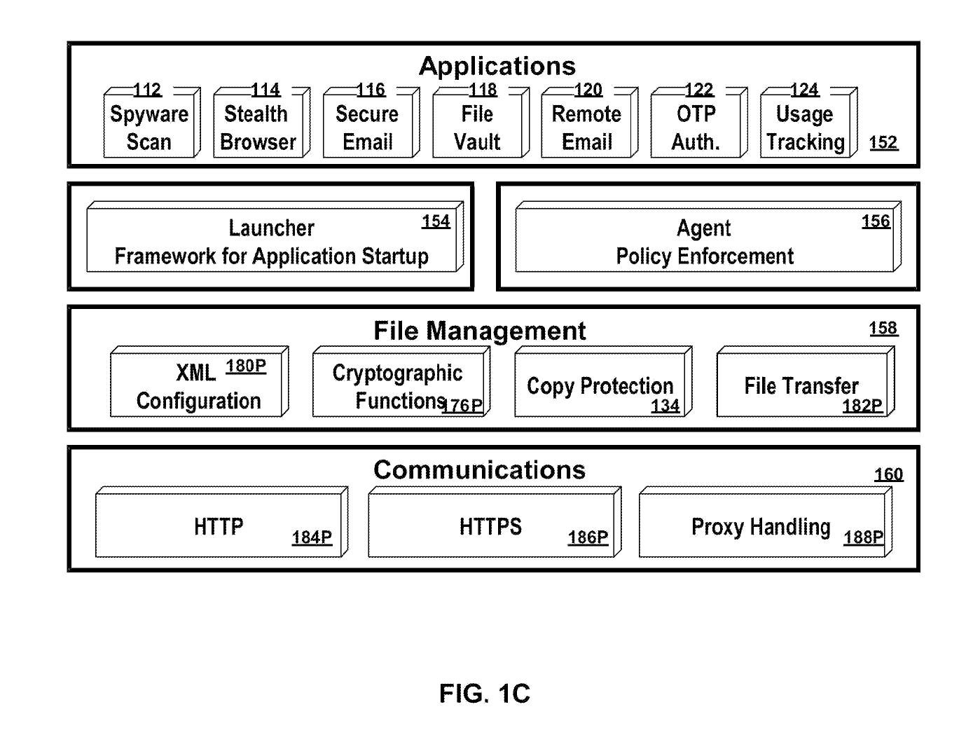

Referring to FIG. 1, an exemplary block diagram of a general purpose computer system 100, 100A, 100B is depicted. The computer system may be configured as an administration server 100, a remote client 100A or a central management console 100B. The computer system 100, 100A, 100B includes a communications infrastructure 90 used to transfer data, memory addresses where data files are to be found and control signals among the various components and subsystems associated with the computer system 100, 100A, 100B.

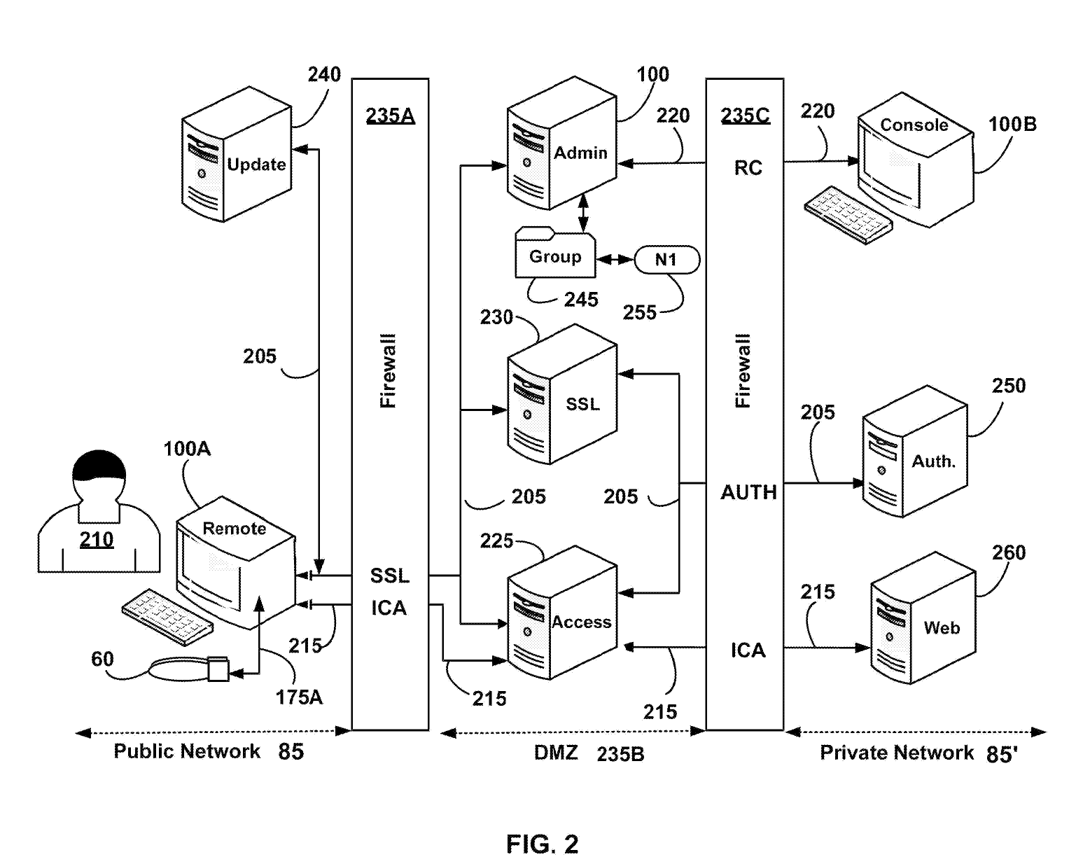

A processor 5 is provided to interpret and execute logical instructions stored in the main memory 10. The main memory 10 is the primary general purpose storage area for instructions and data to be processed by the processor 5. A timing circuit 15 is provided to coordinate programmatic activities within the computer system 100, 100A, 100B and interaction with other computer systems as shown in FIG. 2. The timing circuit 15 may be used as a watchdog timer, clock or as a counter arrangement and may be programmable.

The processor 5, main memory 10 and timing circuit 15 are directly coupled to the communications infrastructure 90. A display interface 20 is provided to drive a display 25 associated with the computer system 100, 100A, 100B. The display interface 20 is electrically coupled to the communications infrastructure 90 and provides signals to the display 25 for visually outputting both graphical displays and alphanumeric characters. The display interface 20 may include a dedicated graphics processor and memory (not shown) to support the displaying of graphics intensive media. The display 25 may be of any type (e.g., cathode ray tube, gas plasma, LCD.) A secondary memory subsystem 30 is provided which houses retrievable storage units such as a hard disk drive 35, a removable storage drive 40, and an optional logical media storage drive 45. One skilled in the art will appreciate that the hard drive 35 may be replaced with flash RAM. The removable storage drive 40 may be a replaceable hard drive, optical media storage drive or a solid state flash RAM device. The logical media storage drive 45 may include a flash RAM device, an EEPROM encoded with one or programs used in the various embodiments described herein, or optical storage media (CD, DVD.)

A generalized communications interface 55 is provided which allows the administration server 100 to communicate over one or more networks 85. The network 85 may be of a wired, optical, or radio frequency type normally associated with computer networks for example, wireless computer networks based on various IEEE standards 802.11x, where x denotes the various present and evolving wireless computing standards, for example WiMax 802.16 and WRANG 802.22.

Alternately, digital cellular communications formats compatible with for example GSM, 3G, CDMA, TDMA and evolving cellular communications standards. In a third alternative embodiment, the network 85 may include hybrids of computer communications standards, cellular standards, cable networks and/or satellite communications standards.

The computer system 100, 100A, 100B includes an operating system for example, Microsoft™ Windows 2000, XP and later versions thereof, or, if arranged as dedicated network appliance, an embedded operating environment for example, Microsoft Windows CE. The computer system 100, 100A, 100B further includes the necessary hardware and software drivers necessary to fully utilize the devices coupled to the communications infrastructure 90 and one or more programs which enable the computer system 100, 100A, 100B to communicate with other computer systems over the network 85.

In an embodiment, software accessible by a central management console 100B allows a systems administrator to remotely define on the administration server 100; a plurality of group folders, separate policies for each of the defined group folders; and assign a plurality of portable end-point security devices (PEPS) 60 to their appropriate group folders through logical nodes such that the appropriate separate policies are inherited by the PEPS 60 once operatively communicating with the administration server 100 over the network 85. The software is generally provided in a client/server arrangement.

Additional software capabilities enable a systems administrator to; centrally manage and track all PEPS 60 connected to the network 85, provision and deploy additional PEPS 60; administer existing PEPS 60 and audit a PEPS 60 from the central management console 100B. In an embodiment, the central management console 100B is provided with a dedicated or otherwise secure connection to an administration server 100. The administration server 100 maintains the group folders, policies, audit logs and logical nodes associated with each of the PEPS 60.

In a remote client configuration, the computer system 100A is operatively coupled to a public network 85 for example, the Internet, and includes an operating system compatible with the operating system deployed on the administration server 100, for example, Microsoft Windows 2000, XP™ or later versions thereof and a compatible communications interface 55 to operatively couple 175A the PEPS 60 to the computer system 100A. In an embodiment, the PEPS 60 is operatively coupled 175A to the communications interface 55 by a universal serial bus (USB) connection. However, other arrangements known in the relevant art such as PCMCIA, BlueTooth™, or infrared optical connections to the communications interface 55 may be used in combination or as a replacement for the USB connection.

Referring to FIG. 1A, the various software applications shared between the central management console 100B and the administration server 100 are depicted according to functional component modules 162, 164, 166. At the highest level, the various management applications 162 for centrally administering the PEPS 60 are provided.

An application provides PEPS file management 164 functions for example, creating group folders and logical nodes, assigning the PEPS to group folders, modifying PEPS group assignments, deleting and/or causing the destruction of a node. A policy management function 166 is provided to create, modify, assign and delete the various policies associated with the PEPS including; security, configuration, storage, remote access, document distribution, authentication, provisioning, password recovery, self-destruction and lockout, licensing, auditing and other functions which are enforced by the PEPS 60. The policies are created and transported to the PEPS 60 using extensible markup language (XML) formatted files which are distributed to the PEPSs 60 assigned to a particular group folder from the administration server 100. The use of XML formatted files provide a convenient platform and software independent data transport medium which is compatible with other common network protocols such as hypertext transport protocol (HTTP) and/or hypertext transport protocol secure socket layer (HTTPS).

In an embodiment, the policies generated by the policy management function 166 may be configured to control the PEPS 60 according to a user's position in an enterprise. For example, group folders may be defined based on commonalities in security policies that must be applied. In general, the most common groupings would be based on departmental or functional hierarchies. In one example, a system administrator could group all PEPS 60 used by members of a department to apply a common security policy. In another example, group folders may be defined by combining all supervisors in one group, all managers in another group, etc. In yet another example, the system administrator may define policies such that an inheriting group of PEPSs 60 incorporates a combination of departmental and management hierarchies within it.

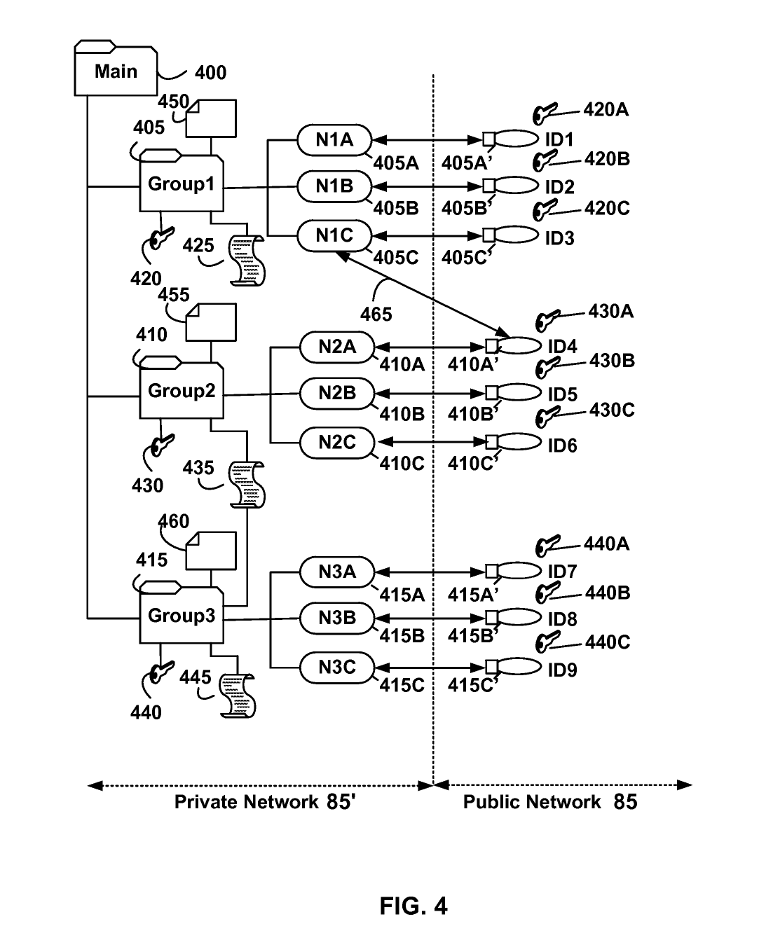

Alternately, or in conjunction therewith, another set of policies may be defined for users within an organization having unique requirements, for example, system administrator level privileges which are limited to a handful of employees. Once created, a policy may be mapped to any number of group folders 405, 410, 415 (FIG. 4) which greatly simplifies the administration of a large number of PEPSs. The policy management function 166 provides remote administrative control of the policies enforced by the PEPS 60 including, remote access rules, mobile storage tracking, user change management, and audit reports of transactions which occurred with an individual PEPS 60.

An update management function 168 is provided which controls the location and periodicity for receiving updates related to policies, malware signatures, licensing, executable code, data, objects and credentials. Policy updates are pushed from an administration server 100 to the PEPS 60 by mapping a new or updated policy to one or more group folders. A particular PEPS 60 polls its assigned group folder on the administration server 100 at update cycles defined by the system administrator.

Once an update cycle is due, the PEPS 60 when connected to the network 85 via the remote computer system 100A, accesses an administration server 100 and connects to its assigned group folder. The PEPS 60 then downloads the new or modified policy(ies) from its associated group folder. Additional types of updates may be received from the administrative server 100 including new or modified user credentials, cryptographic keys and/or salt, commands, universal resource locator (URL) addresses for internal resources and third party services, document distribution policies, etc. The commands may include the downloading of new or updated policies, activation, deactivation, locking or destroying the contents of a particular PEPS 60. The destroy command causes a PEPS 60 to wipe out its internal memory when the command is received to prevent loss of critical information. Execution of a command received by the PEPS 60 usually occurs generally upon receipt from the administration server 100. At any time, any number of PEPS 60 can be deployed, updated, tracked, disabled, locked out and/or destroyed.

For licenses, firmware updates, malware signatures, executable codes, data, and related updates used by the PEPS 60, a license management function is provided 170. In another embodiment, the license management function utilizes a third party service provider. The update frequency for the third party service provider may be established by the third party provider to verify that each PEPS 60 accessing the update server 240 (FIG. 2) has a current license before allowing firmware, executable code and malware updates to be downloaded to the requesting PEPS 60. In an embodiment, the update server 240 functionality may be combined with the administration server 100.

In an alternate embodiment, the system administrator may define the update cycle frequency analogous to the procedure defined for the administration server 100. In an alternate embodiment, all updates are pushed from the administrative server 100. In this alternate embodiment, the third party service provider distributes periodic updates to the system administrator to install on the administration server 100. This alternate embodiment may be used to ensure that a particular update is compatible with installed software, network configurations and hardware before a “live” update is actually pushed to the organizations' PEPS 60.

For secure user authentication, a two factor, one-time password (OTP) function 172 may be implemented by the PEPS 60. Several third party vendors provide secure two-factor authentication products suitable for use with PEPS 60; for example, RSA (TM) SecureID and Verisign™ OATH. The OTP function 172 is intended to operate in conjunction with an enterprise authentication server 250.

A usage tracking function 174 is provided to allow a system administrator to audit transactions which have occurred within a particular PEPS 60. Each PEPS 60 maintains an XML formatted status file which is uploaded to the PEPS's 60 assigned group folder in response to commands received from the administrative server 100. The status file provides limited information on the state of the PEPS 60 following receipt of a command.

In addition, a separate XML formatted log file may be uploaded to the PEPS's 60 assigned group folder when commanded to do so. The criterion to be audited is defined by the system administrator and is incorporated into a usage tracking policy implemented by the PEPS 60. This function is helpful for diagnostic and security purposes.

A second level of management provides file management functions 176 for the PEPS 60. In an embodiment of the invention, the PEPS 60 utilizes extensible markup language (XML) formatted files which are distributed to the PEPSs 60 assigned to a particular group from the administration server 100. The XML files are scripted using an XML configuration manager 178 which allows the creation, modification and deletion of XML formatted files arranged for use by the PEPS 60. The XML formatted files may comprise a composite configuration of security and group policies which are disposed in a designated PEPS's assigned group folder.

A cryptographic functions module 176 is provided to allow for changes in cryptographic information, algorithms and other parameters necessary for secure storage, secure communications and decrypting information downloaded from the PEPS's 60 associated group folder. Both symmetric and asymmetric cryptography algorithms are supported by the PEPS 60.

A command file creation module 182 is provided which causes a new or updated policy to be pushed to the PEPS 60 assigned to a particular group 245 (FIG. 2.) At pre-determined update cycles, the PEPS 60 periodically refers to the command file disposed in the PEPS 60 assigned group folder. When a new or updated policy is detected by the PEPS 60, the command file causes the PEPS 60 to download and install the new or updated policy.

A file transfer module 184 is provided which facilitates all PEPS associated with an assigned group folder to download documents encrypted by the file transfer module 184 using a shared symmetric key specific to the group folder 245 authorized to receive the documents. Only those PEPS 60 assigned to the proper group folder may download and use the encrypted files.

A third level of management 186 is provided to control the communications protocols, proxy and address settings. The communications protocol settings may be configured to support standard HTTP 188, HTTPS 190 support and also provides for proxy handling 192 for virtual private networking (VPN) and secure remote client implementations.

FIG. 1B provides a detailed exemplary functional diagram of a PEPS 60. In various embodiments, the PEPS 60 is disposed in a highly portable form factor similar to common “pen” or “flash” memory drives. An optional microprocessor 105 may be provided to perform cryptographic operations internally rather than utilizing the processor 5 associated with the remote computer system 100A. For example, an ARM7 32-bit processor manufactured by ARM Holdings plc., provides a suitable family of low-power 32-bit RISC microprocessor cores optimized for cost and power-sensitive consumer applications. If present, the processor 105 is operatively coupled to a communications infrastructure 190. A memory subsystem 130 is operatively coupled to the communications infrastructure 190. In various embodiments, the memory subsystem is partitioned into five general functional modules.

In an embodiment, the PEPS 60 is configured as a USB peripheral device which utilizes portions of the operating system (e.g., WINSOCK, MSGINA, LOGON, RUNDLL32 in Microsoft Windows™) and the processor 5 associated with the remote computer system 100A to operate and communicate over the network 85. The PEPS 60 includes a plurality of partitioned memory areas.

An applications module 152 which stores the executable code necessary for executing commands received from command files disposed in the PEPS assigned group folder on the administration server 100.

An AUTORUN module 154 which causes the remote computer system 100A to detect and access the PEPS 60 to operatively load the necessary executable code into the main memory 10 of the remote computer system 100A. In an embodiment, the detection of the coupled PEPS 60 is accomplished using Plug and Play technology known in the relevant art. The executable code is loaded into the main memory 10 of the remote computer system 100A by the file management module 158 and provides the necessary extensions, files, hooks and/or libraries in order to utilize the remaining functions associated with the PEPS 60. In an embodiment, the majority of the processing is performed by the processor 5 associated with remote computer system 100A. Additional processing may be performed by the internal processor 105 for certain cryptographic functions.

A policy agent module 156 is provided which installs and enforces policies downloaded from the PEPS's 60 assigned group folder on the administration server 100.

A file management module 158 is provided which controls internal memory allocation, the transfer of executable code to the main memory of the remote computer system 100A and internal storage of session files. The file management module 158 also ensures that document files downloaded from the PEPS's 60 assigned group folder remain within the secure storage of the PEPS 60 if designated as controlled document files in conjunction with the policy agent module 156.

A communications module is provided 160 to manage the various addressing, communications protocols, and security requirements enforced by the policy agent 156.

A communications interface 155 is operatively coupled to the communications infrastructure 190 to allow the PEPS 60 to communicate with the remote computer system 100A.

Lastly, each PEPS 60 is encoded with a unique identification code ID1 65 which in an embodiment may be burned into an internal EEPROM associated with the PEPS 60 during manufacturing. In an alternate embodiment, the unique identification code ID1 65 may be installed as a permanent file.

Referring to FIG. 1C, the various software applications 152 contained in an embodiment of the PEPS 60 are depicted. The applications are arranged according to their functional component groups 112-124. A spyware scan application 112 is provided to ensure that any spyware or viruses (collectively “malware”) present on the remote computer system 100A do not monitor and/or infect information exchanged with the PEPS 60. In an embodiment, the spyware scan application 112 allows a user to delete detected spyware. In another embodiment, the spyware scan application 112 insulates the operating system kernel from interacting with the detected spyware. In another embodiment, the spyware scan application 112 is configured to scan the remote computer for malware before loading of the other PEPS applications.

A stealth browser application 114 and secure email application 116 are provided to receive and store temporary files, cookies, emails, attachments, documents and browsing histories within the secure confines of the PEPS 60. Storing these data internally prevents another party from recovering these data from the remote computer system 100A. As such, no session traces are left behind on the remote computer system 100A.

A file vault application 118 is provided to maintain document files and other important data in encrypted form within a persistent area of memory of the PEPS 60. Data stored within the file vault is encrypted with the group folder's shared symmetric key. Access to the file vault first requires user authentication to the PEPS 60.

A remote email client 120 application may be provided which allows the use of independent computing architecture (ICA) software solutions, for example, CITRIX (TM) ICA client to be run without having to install the ICA client software on the remote computer system 100A, thus allowing highly secure remote email and VPN communications between a remote host and the local ICA client.

As discussed above, the PEPS 60 may be provided with one or more OTP authentication applications 122 which are configured to provide two-factor authentication with a remote authentication server 250. In an embodiment, digital certifications may be stored within the file vault 118 for performance of three-factor and challenge response authentication.

In an embodiment, PEPS 60 may be provided with a usage tracking application 124 which operates in conjunction with the usage tracking function 174 associated with the central management console 100B and the administration server 100. The usage tracking application provides the PEPS 60 status and activity logs in XML files which are uploaded to the PEPS's 60 assigned group folder following execution of a command (status file) or request (activity log) as is discussed above.

A framework 104 is provided to automatically start the AUTORUN application described above using plug and play technology known in the relevant art. In an embodiment, connecting 175A the PEPS 60 to an available USB port on the remote computer system 100A causes an interrupt signal to be detected by the communications interface 55 (typically a USB controller.) The USB controller determines the type of device connected and signals the processor 5 to run a browser application to review the contents of the attached PEPS 60. The browser locates and executes the AUTORUN application installed in the PEPS 60. The AUTORUN application transfers the initial executable code into the main memory 10 of the remote computer system 100A. Once loaded, the initial executable code loads additional executable code selected from the appropriate PEPS applications 152 as needed. In a Windows embodiment, loading of the various applications may be performed using an MSI file or third party installation application.

Also as discussed above, a policy agent enforcement module 156 is provided which installs and enforces policies downloaded from the PEPS's 60 assigned group folder from an administration server 100. The policy enforcement agent 156 ensures that the PEPS 60 usage requirements specified by the systems administrator in various policies are implemented by the PEPS 60.

There are several types of policies which may be operatively stored in the PEPS 60 including security policies, authentication policies, configuration policies, document management policies, connectivity policies, logical storage policies and cryptography policies. In an embodiment, the policies are provided in XML format which are commonly shared with all PEPSs 60 assigned to a particular group folder.

As discussed above, a file management application 158 is provided which controls internal memory allocation, the transfer of executable code to the main memory of the remote computer system 100A, and storage of session files. The file management application 158 also ensures that document files downloaded from the PEPS's 60 assigned group folder remain within the secure storage of the PEPS 60 if designated as controlled document files in conjunction with the policy agent application 156 and cryptographic functions application 176P, and copy protection application 174.

An XML configuration application 180P is provided to receive the various policies distributed from the PEPS assigned group folder, extract the data residing therein distribute the extracted data to the various applications 152 requiring the data, and package outgoing data in XML files for review by the usage tracking application 174.

The cryptographic functions application 176P maintains the cryptographic algorithms and data used by the stealth browser 114, secure email 116, file vault 118, copy protection 134 and authentication applications 122. Both symmetric and asymmetric cryptographic functions may be incorporated into the cryptographic functions application. In an embodiment, symmetric encryption which utilizes a FIPS 140-2 certified 128 bit or greater advanced encryption standard (AES) algorithm for secure storage of controlled document files in the file vault 118. In an embodiment, the contents of the PEPS's 60 assigned group folder is encrypted and utilizes a shared secret symmetric key assigned to the group folder to decrypt and use the files downloaded therefrom.

A copy protection application 134 is provided to ensure that controlled document files stored in the file vault 118 are not copied from the secure storage if prohibited by the policy enforcement application 156. The copy protection application 134 operates in conjunction with the policy enforcement application 156, file vault 118, file transfer application 182P and cryptographic functions application 176P to prevent unauthorized use or access of the controlled document files.

A file transfer application 182P is provided which controls internal memory allocation, the transfer of executable code to the main memory of the remote computer system 100A, receipt of files distributed from the assigned PEPS's group folder, internal storage of session files and transfer of XML files generated by the PEPS 60 to the administration server 100. The file management application 182P also ensures that document files downloaded from the PEPS's 60 assigned group folder remain within the secure storage of the PEPS 60 if designated as controlled document files in conjunction with the policy agent application 156.

Communications applications 160 are provided to control the communications protocols, proxy and address settings. The communications protocol settings may be configured to support standard HTTP 184P, HTTPS 186P support and also provides for proxy handling 188P for virtual private networking (VPN) and secure remote client implementations. The communications applications 160 work in conjunction with the stealth browser, secure email, remote email, and policy agent 156. One skilled in the art will appreciate that the communications applications are well understood in the relevant art.

Referring to FIG. 2, an exemplary network 85, 85′ configuration embodiment is depicted where a user 210 is situated at a remote computer system 100A, perhaps at an internet cafe or similar setting and is attempting to gain access to confidential document files stored in a group folder 245. The user 210 operatively couples 175A, his or her assigned PEPS 60 to the remote computer system 100A. An AUTORUN application 154 may be employed to cause the PEPS 60 to begin scanning the remote computer system 100A for malware. The PEPS 60 may be configured to bypass the malware scan if the remote computer system 100A and/or the network connection 205 is determined by the PEPS 60 to be trusted as prescribed by one or more internal policies. In general, an unknown remote computer system 100A is scanned for malware before transactions are allowed using the PEPS 60.

Once this process completes, the user 210 may be notified by a color-coded graphic to remove or quarantine any detected malware. In an embodiment, a yellow graphic indicates that low to medium risk malware is present and the user 210 should, if possible, remove or quarantine the detected malware before using the remote computer system 100A. A red graphic indicates that high risk malware, such as a key-logger is present and the user 210 should not continue without removing or quarantining the high risk malware. Conversely, if no malware is detected, a green graphic indicates that the remote computer system 100A is safe to use.

Once the user 210 has acted accordingly, the user 210 is prompted by the PEPS 60 to enter his or her username and password to gain at least local access to the PEPS 60. In an alternate embodiment, the user's 210 username and password may be synchronized with a user's normal login credentials, using for example, WINLOGON.EXE when coupled to a trusted computer system 100A. This embodiment of the invention limits the number of different credentials the user 210 has to remember or supply to gain access to the remote computer system 100A. If a two factor authentication process, for example, generation of a one time password 122, is required to access the user's private network 85′, a second authentication transaction is conducted between the PEPS 60 and the authentication server 250 which authenticates the PEPS 60 to the authentication server 250. The authentication between the PEPS 60 and the authentication server 250 may utilize any standard mechanism, including digital certificate exchange, challenge-response, etc.

Once the authentication process has been successfully completed, the PEPS 60 allows the user 210 to browse the contents of data files contained in his or her assigned group folder 245 on the administration server 100. Each PEPS 60 may be provisioned to access one or more group folders 245 in accordance with its inherited policies.

In another embodiment of the invention, initial provisioning of the PEPS 60 may utilize existing directory information; for example, usernames, domain names, organizational information, permissions, etc. can be migrated from an ANSI X.500 series compliant lightweight directory access protocol (LDAP) or Microsoft's semi-proprietary Active Directory services, thus simplifying the amount of data entry required by the systems administrator.

One skilled in the art will appreciate that the administration server 100 may be a network storage appliance, combined with another server, a dedicated computer system or similar intelligent networked device which is coupled to the between the private 85′ and public 85 networks via the firewall's DMZ 235B configuration settings.

In an embodiment, the information contained in the assigned group folder 245 is stored in encrypted form and will need to be decrypted using a shared symmetric key common to all PEPS 60 assigned to the same group folder 245.

A more detailed discussion of this and other embodiments is provided below in the discussion accompanying FIG. 4. A pending policy update present in the group folder 245 is “pushed” to the PEPS 60 by a command file 178 disposed in the group folder 245 by the systems administrator. The file transfer application 182P operatively downloads the updated policy file(s) to the PEPS 60 for enforcement by the PEPS 60 internal policy agent 156.

Administration of the PEPS 60 is performed from a central management console 100B connected to the administration server 100 using a restricted connection (RC) 220; preferably using a secure communications protocol for example, SSL, SSH or IPSec. The central management console 100B enables a system administrator to simply deploy, administer and audit a plurality of PEPS 60 from a secure location “hidden” from the public network 85 from behind the enterprise firewall 235C. Any number of PEPS 60 can be deployed, updated, tracked, disabled, locked out and/or destroyed by creating, updating or deleting the XML file based policies distributed from the administration server 100. The XML files may include one or more of a digital signature, a checksum, encrypted information to ensure data integrity and/or data security.

One skilled in the art will appreciate that several administrative servers 205 and/or central management consoles 100B may be employed to suit a particular organizations' requirements. The architecture depicted in this FIG. 2, is for exemplary purposes only.

In various embodiments, communications 205 between the PEPS 60 and/or remote computer system 100A and the various severs 100, 225, 230, 240, 250, 260 utilize industry standard secure communications protocols for example, SSL, HTTPS or IPSec. Alternately, or in addition thereto, remote client communications using for example, CITRIX based services between the PEPS 60, access server 225 and a CITRIX host 260 may utilize ICA specific protocols 215.

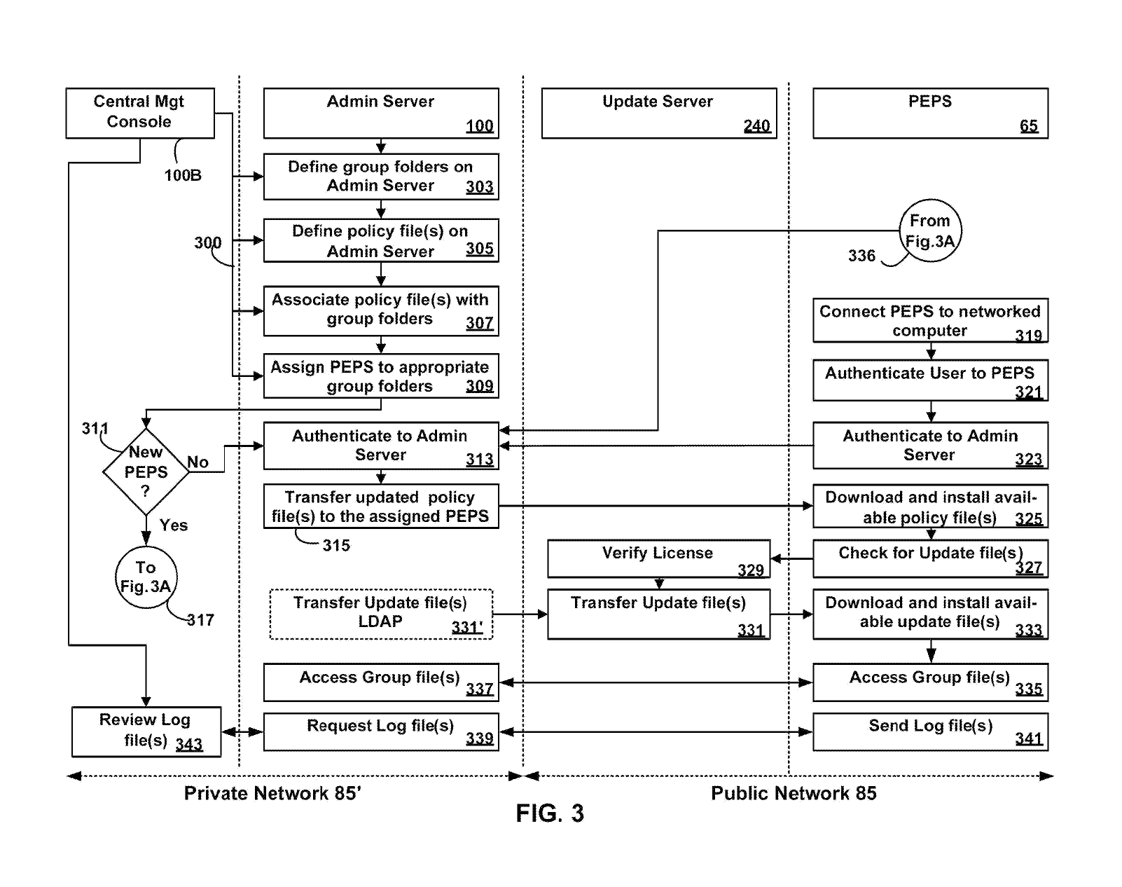

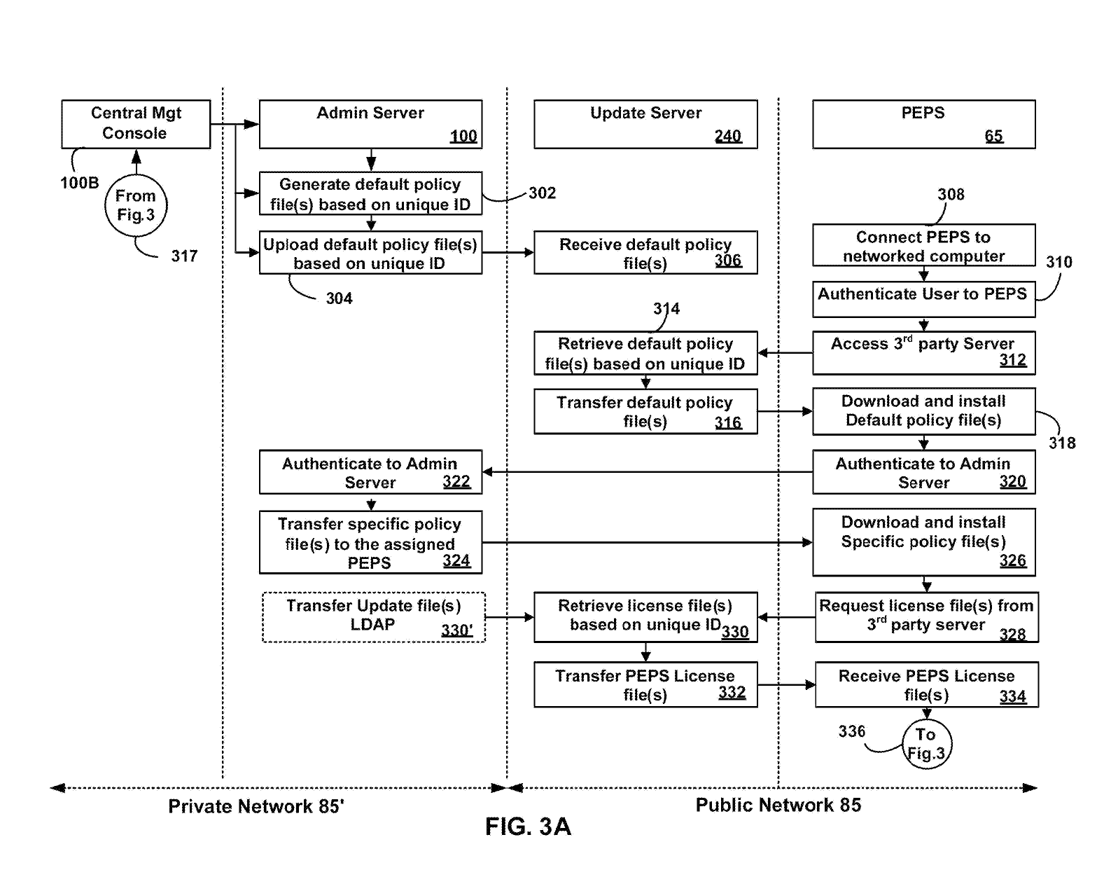

Referring to FIG. 3, an exemplary process flowchart is presented which provides a general overview of the various interactions occurring between the central management console 100B, administration server 100, update server 240 and PEPS 60. The process is initiated 300 by a system administrator defining a plurality of group folders on the administration server 303 from the central management console 100B. Once the group folders have been established, the system administrator defines one or more policies files on the administration server 305. As previously discussed, the group folders and policy files may be defined according to an organization's corporate structure or functional subparts thereof.

Following policy file creation, the system administrator associates the policies with the appropriate group folders 307 to implement a practical and easy to manage security, connectivity, document control, licensing and configuration for each PEPS 60 to be assigned to a particular group folder.

Assignment of the PEPS 60 to their predetermined group folders are then accomplished by the system administrator 309 using the PEPS management application 164 previously discussed. If this is a new provisioning event 311, an additional set of processes is performed 317 as provided in the discussion accompanying FIG. 3A. Otherwise, the remaining interactions occur when the user associated with a particular PEPS 60 operatively connects his or her PEPS 60 to a networked computer system 319.

In an embodiment, the PEPS 60 operatively loads the necessary executable files into the remote computer system. A malware scan may be conducted as previously discussed, and the user is then required to enter his or her credentials. The credentials may be in the form of a username/password pair, biometric scan, code, PIN or other common mechanism known in the relevant art 321. Once successfully authenticated to the PEPS 60, a second authentication transaction 323 may be initiated which authenticates the PEPS 60 to the administration server 315, for example, by providing a OTP generated by the OTP application 122 previously discussed.

In another embodiment, a representation of the authenticated username/password pair is sent to the administration server 100 which authenticates the representation 313. The actual username/password pair does not actually need to be sent. For example, a hash of both entries may be concatenated and sent in an encrypted form. Alternately, a unique identifier associated with the PEPS 60 and a hash of the password may be sent as well. One skilled in the art will appreciate that these techniques are well known in the relevant art.

Once the administration server 100 has authenticated the user's credentials, any pending policy updates and a download command file are disposed in the PEPS 60 assigned group folder 315. The counterpart file transfer applications 182/182P downloads and installs the updated policy 325. The PEPS 60 may then check for executable code or malware signature updates from an update server 240. In an embodiment, the update server 240 is associated with a third party service provider. The third party service provider may be used to provide certain of the updates, for example malware signatures and proprietary executable code updates not normally maintained by the organization.

The update server 240 first verifies the license status and group folder specific policy authorizations 329. If a valid license file is not present, updating may be inhibited and the user is notified that their PEPS license is invalid (not shown.) If the PEPS license is valid and update files are available, the update files and a download command file are disposed in a temporary folder on the update server 240 to which the PEPS 60 is temporarily assigned 331. As before, the counterpart file transfer applications 182/182P downloads and installs the updated executable code files and/or malware definitions files 333. In an alternate embodiment, resynchronization of the PEPS 60 may utilize information contained in an X.500 compliant directory 331′ to update at least a portion of the information required by the separate policies.

After the PEPS 60 has completed the update file cycle, the PEPS 60 is now available to access its assigned group folder 335 and upload or download document files and other files from the group folder 337 established by its inherited policies As previously discussed, the information contained in the assigned group folder may be stored in encrypted form and if so, will require decryption, generally using a shared symmetric key common to all PEPS 60 assigned to the same group folder.

For audit tracking purposes, the system administrator may, from the central management console 100B request 339 a log file from a particular PEPS 60 be returned to the administration server 100. The log request command is disposed in the PEPS assigned group folder. The next time the PEPS 60 polls its assigned group folder, the command file is executed and the requested log file is uploaded 341 to the PEPS group folder 343 which may be accessed from the central management console 100B for review.

Referring to FIG. 3A, an exemplary process flowchart is presented which provides a general overview of the various interactions occurring between the central management console 100B, administration server 100, update server 240 and PEPS 60 when a new PEPS 60 is being provisioned for remote use over a private network 85′.

In this embodiment, the system administrator, from the central management console 100B generates one or more default policy files 302 on the administrative server 100 which may be indexed using the unique identifier 65 associated with new PEPS 60 to be provisioned. The default policy files are then uploaded 304 to the update server 240.

The administrative server 100 exports the default policies to the update server 240 and associates each PEPS unique identifier with a group folder the default policies which are stored on the update server 240 until the associated PEPS 60 requests an update 306 from the update server 240.

The newly issued PEPS 60 is connected to a remote networked computer system 308, authenticates its assigned user to the PEPS 310 may then access the update server 312. The update server 240 retrieves the default policy file(s) or separate policy files(s) 315 from a datastore using the PEPS unique identifier 314, disposes a command file in the temporary folder created for the requesting PEPS and causes the default policy file(s) to be transferred to the PEPS 316. The file transfer application 182 then downloads and installs the default policy file(s) 318.

The PEPS 60 then authenticates to the administration server 320, 322. The administration server 100 retrieves the specific policy file(s) for the PEPS 60 based on its unique identifier, disposes a command file in the temporary folder used for initial provisioning and causes the specific policy file(s) to be transferred 324 to the PEPS 60. The file transfer application 182 then downloads and installs the specific policy file(s) 326.

The PEPS then checks for executable code or malware signature updates from the update server 328. The update server retrieves 330 the activated license file and any available executable or malware update files based on the PEPS unique identifier, disposes a command file in the temporary folder used for activating the PEPS and causes the updated files 332 to be transferred to PEPS 60. In an alternate embodiment, provisioning of the PEPS 60 may utilize information contained in an X.500 compliant directory 330′ to populate at least a portion of the information required by the separate policies. The file transfer application 182 then downloads and installs any updated executable, malware files and the active PEPS license policy file(s) 334 and resumes normal provisioned operations by performing the authentication process 336 with the administration server as shown in FIG. 3.

Referring to FIG. 4, an exemplary data structure is depicted. The data architecture is configured to manage a plurality of PEPSs 420A, 420B, 420C, 430A, 430B, 430C, 440A, 440B, 440C assigned to an organization, typically an enterprise.

A plurality of separate policy file(s) 425, 435, 445 may be defined by a systems administrator from a central management console 100B and configured for access from an administration server 100.

A plurality of group folders may be defined 405, 410, 415, for example, under a common organizational folder 400. The main group folder 400 may be used to define a common set of policies in which all group folders share 405, 410, 415. For example, in a corporate structure, all the PEPSs associated with a particular division may incorporate division specific policies which may not be particularly relevant to other corporate divisions.

Each group folder 405, 410, 415 may have assigned a plurality of uniquely identified nodes. For example group folder 1 405 has assigned nodes 405A, 405B, 405C which are individually accessed by PEPS 405A′, 405B′, 405C′; group folder 2 410 has assigned nodes 410A, 410B, 410C which are individually accessed by PEPS 410A′, 410B′, 410C; likewise, group folder 3 415 has assigned nodes 415A, 415B, 415C which are individually accessed by PEPS 415A′, 415B′, 415C. Thus, in an embodiment, access to the individual nodes requires a PEPS to have the corresponding unique identifier to the specific node.

Policy requirements are assigned to each group folder 405, 410, 415 are controlled by its associated policy files 425, 435, 445. The policy requirements may include network security, licensing, malware detection, PEPS configuration, logical access, logical storage audit tracking, connectivity, licensing, device configuration, executables, data and management of documentation authorized for a particular group folder. The policy requirements are inherited by all PEPSs assigned to each particular group folder. For example, policy requirements associated with Group 1 405 are inherited from the policy file 425 and are binding on the PEPS having ID1 405A′, ID2 405B′, ID3 405C′ which connect to nodes N1A 405A, N1B 405B, N1C 405C.

In an embodiment, a single policy file 435 may be mapped to one or more group folders 410, 415. For example group folder 2 410 is mapped to a policy file 435 in common with group folder 3 415. In addition group folder 3 415 is mapped to an additional policy file 445. As such, all PEPS 410A′, 410B′, 410C′ assigned to group folder 2 410 inherit the policy requirements of the policy file 435 mapped in common with group folder 3 415. However, the PEPS 415A′, 415B′, 415C′ assigned to group folder 3 415 inherit both the policy requirements of the policy file in common with group folder 2 435 and the individually mapped policy file 445 mapped to group folder 3 415. The ability to map one or more policy files provides greater flexibility for a system administrator to customize the policies for particular organizational changes.

As is apparent, the group folders 405, 410, 415 share a one-to-many relationship with their assigned PEPS. However, the PEPS may be provisioned to share a many to many relationship with one or more of the group folders 405, 410, 415. For example, the PEPS 410A′ may be provisioned to allow access 465 to both group folders 1 and 2 405, 410. In this case, PEPS 410A′ would inherit the policy files 450, 455 associated with both group folders 1 and 2 405, 410. The inheriting PEPS 410A′ would then implement the more restrictive of the two combined policies 450, 455 inherited from both group folders 1 and 2 405, 410.

In an embodiment, the contents of each group folder 405, 410, 415 may be encrypted with a symmetric key 420, 430, 440. The symmetric keys 420, 430, 440 are specific to a group folder 405, 410, 415 and are only shared with the PEPS assigned to a particular group folder. For example, the contents of group folder 3 415 may be encrypted using a symmetric key 440 which is shared with its assigned PEPS 415A′, 415B′, 415C′. A confidential document file 460 associated with group folder 3 415 may only be used by persons assigned to PEPS 415A′, 415B′, 415C′ even though group folder 2 410 and group folder 3 415 share a common policy file 435. This arrangement allows for document control and distribution with persons assigned to a particular group folder, but is otherwise unreadable to persons having a PEPS not assigned to the particular group folder since these individuals lack the proper symmetric key to decrypt the document.

Various embodiments have been described in detail with reference to exemplary configurations and processes. It should be appreciated that the specific embodiments described are merely illustrative of the principles underlying the inventive concepts. It is therefore contemplated that various modifications of the disclosed embodiments will, without departing from the spirit and scope of the various embodiments, be apparent to persons of ordinary skill in the art. As such, the foregoing described embodiments of the invention are provided as exemplary illustrations and descriptions. They are not intended to limit the invention to any precise form described. In particular, it is contemplated that functional implementation of the inventive embodiments described herein may be implemented equivalently in hardware, software, firmware, and/or other available functional components or building blocks. No specific limitation is intended to a particular arrangement or process sequence. Other variations and embodiments are possible in light of above teachings, and it is not intended that this Detailed Description limit the scope of inventive embodiments, but rather by the Claims following herein.

What is claimed:

1. A system for centrally managing policy files prescriptively assignable to a plurality of portable end-point security devices over a network comprising:
a central management console in processing communications with at least one administration server, said central management console being configured to;
define a plurality of group folders on said at least one administration server; said plurality of group folders being permissively accessible by said plurality of portable end-point security devices upon presentation of proper credentials to at least said plurality of portable end-point security devices;
define separate file-based policies for each of said plurality of group folders;
selectively assign said plurality of portable end-point security devices to one or more of said plurality of group folders in at least partial dependence on said defined separate policies;
wherein said separate policies are inherited by said portable end-point security devices from said assigned plurality of group folders when operatively coupled thereto.

2. The system according to claim 1 wherein said selectively assign maps each of said plurality of portable end-point security devices to a plurality of uniquely identified nodes in relational correspondence with a unique identifier assigned to each of said plurality of portable end-point security devices.

3. The system according to claim 2 wherein said plurality of uniquely identified nodes represents an address in which a member of said plurality of portable end-point security devices accesses its assigned group folder.

4. The system according to claim 1 wherein a relational correspondence between each of said plurality of group folders to each of said plurality of portable end-point security devices includes a one-to-many relationship.

5. The system according to claim 1 wherein a relational correspondence between each of said plurality of portable end-point security devices to each of said plurality of group folders includes a many-to-many relationship.

6. The system according to claim 1 wherein said separate policies are sharable between one or more of said plurality of group folders.

7. The system according to claim 1 wherein a member of said plurality of portable end-point security devices inherits said separate policies from each of said plurality of group folders to which said member is assigned.

8. The system according to claim 7 wherein said member implements the more restrictive policies inherited for resolution of potential conflicts.

9. The system according to claim 1 wherein said proper credentials are first provided to said plurality of portable end-point security devices and another set of proper credentials is provided to said at least one administrative server to access said assigned group folders.

10. The system according to claim 9 wherein said another set of proper credentials is obtained from a unique set of credentials internal to said plurality of portable end-point security devices.

11. The system according to claim 1 wherein at least some information included in at least a portion of said separate policies is retrieved from an X.500 compliant directory.

12. The system according to claim 1 wherein said plurality of group folders at least intermittently contain policy update files for inheritance by said selectively assigned plurality of portable end-point security devices.

13. The system according to claim 1 wherein each of said plurality of portable end-point security devices is configured to enforce said inherited separate policies when operatively coupled to a computer system.

14. The system according to claim 1 wherein said separate policies includes one of, an executable code, a data file, an object, an application policy, a security policy, a license policy, a malware policy, a configuration policy, a connectivity policy, a storage policy, an auditing policy, a document management policy and any combination thereof.

15. The system according to claim 1 wherein said separate policies are distributed from said at least one administration server to each of said plurality of portable end-point security devices in at least partial dependence on a unique identifier associated with each of said plurality of portable end-point security devices.

16. The system according to claim 1 wherein said separate policies are distributed from said plurality of separate group folders in an XML format.

17. The system according to claim 1 wherein said separate policies includes different requirements based on trusted and untrusted configurations.

18. The system according to claim 17 wherein said trusted and untrusted configurations are dependent at least in part on one of; a local host connection, a network connection, a location, a network domain and any combination thereof.

19. The system according to claim 1 wherein each of said plurality of portable end-point security devices comprises a handheld computer peripheral device connectable to a computer system through a communications channel.

20. The system according to claim 16 wherein said XML format further includes one of; a digital signature, a checksum, encrypted information and any combination thereof.

21. A method for centrally managing policy files prescriptively assignable to a plurality of portable end-point security devices over a network comprising:
defining a plurality of group folders on at least one administration server; said plurality of group folders being permissively accessible by said plurality of portable end-point security devices upon presentation of proper credentials to at least said plurality of portable end-point security devices; defining separate file-based policies for each of said plurality of group folders;
selectively assigning said plurality of portable end-point security devices to one or more of said plurality of group folders in at least partial dependence on said defined separate policies;
wherein said separate policies are inherited by said portable end-point security devices from said assigned plurality of group folders when operatively coupled thereto.

22. The method according to claim 21 further including assigning each of said plurality of portable end-point security devices to a plurality of individually assigned nodes having many-to-many relationships with said assigned plurality of group folders.

23. The method according to claim 21 further including receiving a license policy from said at least one of; an administration server, an update server and a third party service provider.

24. The method according to claim 21 further includes initially provisioning said plurality of portable end-point security devices with one or more default policies prior to inheriting said separate policies.

25. The method according to claim 21 further including accessing said at least one administration server at least intermittently to receive policy update files from said assigned plurality of group folders.

26. The method according to claim 21 further including authenticating a user to at least one of said plurality of portable end-point security devices prior to accessing said at least one administration server.

27. The method according to claim 21 wherein said separate policies includes one of; an executable code, a data file, an object, an application policy, a security policy, a license policy, a malware policy, a configuration policy, a connectivity policy, a storage policy, an auditing policy, a document management policy and any combination thereof.

28. The method according to claim 24 further including distributing said separate policies to each of said plurality of portable end-point security devices in at least partial dependence on said default policies.

29. The method according to claim 21 wherein each of said plurality of portable end-point security devices comprises a handheld computer peripheral device connectable to a computer system through a communications channel.

30. The method according to claim 21 wherein each of said plurality of portable end-point security devices is configured to enforce said inherited separate policies when operatively coupled to a computer system.

31. The method according to claim 21 wherein said separate policies are distributed from said plurality of separate group folders in an XML format.

32. The method according to claim 31 wherein said XML format further includes one of; a digital signature, a checksum, encrypted information and any combination thereof.

33. A computer program product embodied in a tangible form comprising executable instructions for a processor associated with at least one administration server to:
generate a plurality of group folders on said at least one administration server; said plurality of group folders being permissively accessible by a plurality of portable end-point security devices upon presentation of proper credentials to said at least one administration server; generate separate file-based policies for each of said plurality of group folders;
selectively assign said plurality of portable end-point security devices to one or more of said plurality of group folders in at least partial dependence on said defined separate policies;
wherein said separate policies are inherited by said portable end-point security devices from said assigned plurality of group folders when operatively coupled thereto.

34. The computer program product according to claim 33 further including executable instructions by said processor to; assign each of said plurality of portable end-point security devices to a plurality of nodes having unique identifiers corresponding to those of said plurality of portable end-point security devices.

35. The computer program product according to claim 33 wherein each of said plurality of portable end-point security devices comprises a handheld computer peripheral device connectable to a computer system through a communications channel.

36. The computer program product according to claim 33 wherein said separate policies are distributed in an XML format to each of said plurality of portable end-point security devices as part of said inherited.

37. The computer program product according to claim 33 wherein said assign maps each of said plurality of portable end-point security devices to a plurality of individually assigned nodes having many-to-many relationships to said assigned plurality of group folders.

38. The computer program product according to claim 33 wherein said tangible form comprises magnetic media, optical media, logical media and any combination thereof.

39. The computer program product according to claim 36 wherein said XML format further includes one of, a digital signature, a checksum, encrypted information and any combination thereof.

40. The computer program product according to claim 33 wherein each of said plurality of portable end-point security devices is configured to enforce said inherited separate policies when operatively coupled to a computer system.
